(19) United States
(12) Patent Application Publication
(10) Pub. No.: US 2012/0122056 A1
(43) Pub. Date: May 17, 2012

(54) DENTAL IMPLANT

(76) Inventor: Man Yong KIM, Seoul (KR)

(21) Appl. No.: 13/288,227

(22) Filed: Nov. 3, 2011

(30) Foreign Application Priority Data
Nov. 17, 2010 (KR) 10-2010-0114278

(51) Int. Cl. A61C 8/00

(52) U.S. Cl. 433/173

(57) ABSTRACT

A dental implant, in which a crown made of zirconia is coupled and joined to an abutment by first and second joining holes that are concentrically formed in the crown and the abutment and a joining pin that is inserted into the first and second joining holes. Thus, the crown can be fixed to the abutment through simple structure and method which prevents a separation of the crown from the abutment after fixing. The crown can be easily removed by removing the joining pin without damage to the crown. A housing is mounted inside the first joining hole of the crown and the housing is screw-coupled with the joining pin or the joining pin is fixed by a magnetic force to thereby prevent a separation of the joining pin.

### BACKGROUND OF THE INVENTION

1. Field of the Invention

This application claims priority under 35 U.S.C. §119 from Korean Patent. Application No. 10-2010-0114278 filed Nov. 17, 2010, incorporated herein by reference in its entirety for all purposes.

The present invention relates to a dental implant, and more particularly, to a dental implant, in which a crown made of zirconia with the highest intensity and aesthetic appreciation of ceramic materials is coupled and joined to an abutment by first and second joining holes that are concentrically formed in the crown and the abutment respectively and a joining pin that is inserted into the first and second joining holes.

2. Background Art

In general, an implant originally means a replacement for recovering lost body tissues when tissues of the human body are lost, but means a transplantation of an crown in a dental surgical field. The implant is the technology for recovering the original function of a lost tooth through the steps of planting a root (fixture) made of titanium, which does not cause rejection symptoms to the human body into an alveolus (tooth-socket) so as to act as a substitute for a root of the lost tooth, and then fixing a crown (crown).

A general prosthesis or a denture has a demerit in that it damages teeth and bone around the prosthesis or the denture over time, but the implant has a merit in that it does not damage teeth tissues around the implant and can be used for a long time since it does not cause a decay of teeth while providing function and shape similar to natural teeth.

Moreover, the implant is effective for restoration of a single missing tooth, promotes the functions of artificial teeth for patients with partial anodontia or total anodontia, and enhances an aesthetic sense of a dental prosthetic restoration. Furthermore, the dental implant can disperse excessive stress applied to the surrounding support bone and help a set of teeth be stabilized.

There are various kinds of implant surgeries, and one of them will be described as follows.

First, a hole corresponding to the dimensions of the fixture is formed in the alveolar bone through drilling and tapping processes, and then, a mount is joined to an upper portion of the fixture. After that, the fixture and the mount are implanted into the alveolar bone using a dental handpiece, and then, the fixture is implanted into the alveolar bone by removing the mount from the fixture. Additionally, the fixture is sutured by joining a cover screw onto the top of the fixture, and thereby, the first operation is finished.

The cover screw serves to prevent that germs and foreign matters existing in the oral cavity invade the inside of the fixture while a patient waits for osseointergration of the fixture. The period of osseointergration is varied according to the patient's bony tissues and implantation places, but is generally in a range of three months to six months.

Continuously, in the second surgical operation, the cover screw is exposed to the outside by opening the gum, and then, is removed after the level of the osseointergration is checked. Moreover, in order to form an aesthetic gum, a healing abutment is joined to the upper portion of the fixture, and then, the patient waits two weeks or three weeks. Recently, in order to improve the complex second surgical operation, the first surgical operation of directly joining the healing abutment to the fixture without carrying out the process of joining and removing the cover screw is used.

Next, after formation of the aesthetic cum is checked, the healing abutment is removed, and then, an impression coping is joined to the top of the fixture to produce a prosthesis. Continuously, preliminary impressions are obtained inside the oral cavity using an impression material, and then, the impression coping is removed.

After that, an crown is completed through the steps of manufacturing a teeth mold, processing a crown, joining the abutment to the top of the fixture, and fixing the crown onto the abutment.

In the above-mentioned implant surgical procedure, in order to adhere the crown to the abutment, there is a representative method of bonding the crown to the abutment using dental cement.

However, the method of bonding the crown to the abutment using the dental cement has a problem in that the crown must be destroyed in a case that there is a need to remove the crown for repairing or treating the crown, the fixture or the abutment.

Furthermore, in order to solve the above problem, a weak adhesive agent may be used to make the removal of the crown easy, but in this instance, the patient may be embarrassed due to a sudden separation of the crown during eating and may swallow the crown together with foods in a severe case.

### SUMMARY OF THE INVENTION

Accordingly, the present, invention has been made to solve the above-mentioned problems occurring in the prior arts, and it is an object of the present invention to provide a dental implant, in which a crown made of zirconia with the highest intensity and aesthetic appreciation of ceramic materials is coupled and joined to an abutment by first and second joining holes that are concentrically formed in the crown and the abutment and a joining pin that is inserted into the first and second joining holes, whereby the crown made of the zirconia material can be fixed to the abutment through simple structure and method, it can prevent a separation of the crown from the abutment after the fixing, and the crown can be easily removed only by removing the joining pin without any damage of the crown.

It is another object of the present invention to provide a dental implant, in which a housing is mounted inside the first joining hole of the crown and the housing is screw coupled with the joining pin or the joining pin is fixed via a magnetic force to thereby prevent a separation of the joining pin.

To accomplish the above object, according to the present invention, there is provided a dental implant, which includes a fixture inserted and joined into an alveolar bone to a predetermined depth to form an artificial dental, root, a crown forming the outward appearance of the artificial root and having a joining recess that is formed therein and is opened at a side, an abutment having an end portion inserted and joined into the joining recess of the crown and the other end portion joined with the fixture, and joining means for joining the crown and the abutment with each other, wherein the joining means includes: a first joining hole penetrating a side of the joining recess of the crown; a second joining hole formed on the outer periphery of the abutment, the second joining hole being formed concentrically with the first joining hole; and a joining pin inserted into the first joining hole and the second joining hole to thereby couple and join the crown and the abutment with each other.

As described above, in the dental implant according to the present invention, the crown made of zirconia with the highest intensity and aesthetic appreciation of ceramic materials is coupled and joined to the abutment by the first and second joining holes that are concentrically formed in the crown and the abutment and the joining pin that is inserted into the first and second joining holes, whereby the crown made of the zirconia material can be fixed to the abutment through the simple structure and method, it can prevent a separation of the crown, from the abutment after the fixing, and the crown can be easily removed only by removing the joining pin without any damage of the crown.

Moreover, the housing is mounted inside the first joining hole of the crown and the housing is screw-coupled with the joining pin, or the joining pin is fixed by a magnet mounted at an end portion of the joining pin via a magnetic force to thereby prevent a separation of the joining pin.

Furthermore, the precision-machined housing is inserted and joined into the first joining hole of the crown, which is difficult to be precision-machined, so as to support the outer periphery of the joining pin, and then, there is no interval between the crown and the joining pin, and it causes no interval between the crown and the abutment, which are coupled with each other through the joining pin, whereby it improves durability of the implant.

Additionally, the crown made of the zirconia material can be used by means of the joining means to thereby enhance durability of the crown.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is an exploded perspective view of a dental implant according to the present invention;

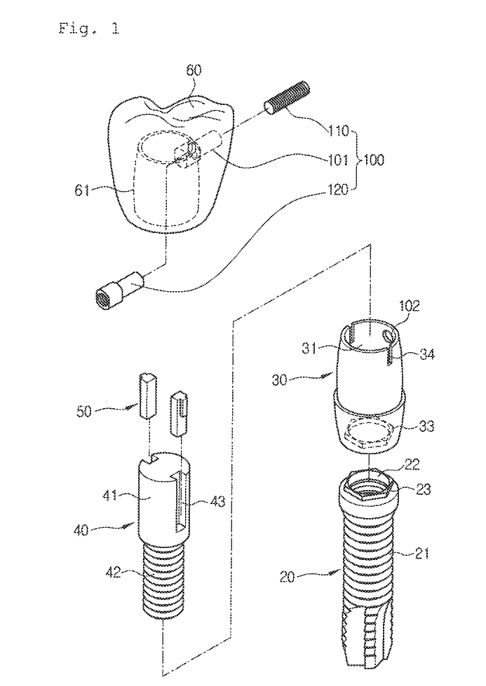

FIG. 2 is a perspective view of the dental implant according to the present invention;

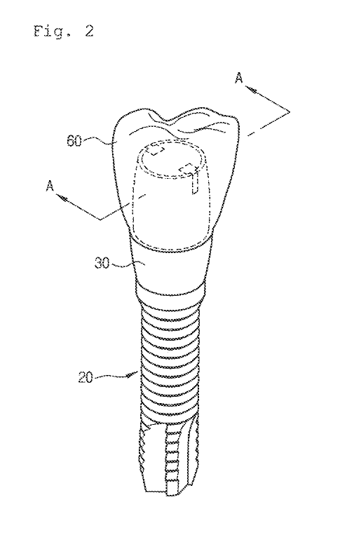

FIG. 3 is a sectional view taken along the line of A-A of FIG. 2;

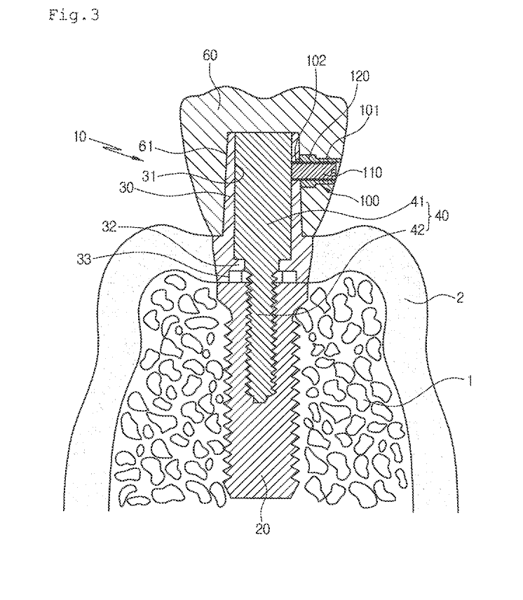

FIG. 4 is a sectional view of joining means of the dental implant according to a first preferred embodiment of the present invention;

FIG. 5 is an exploded perspective view of the joining means of FIG. 4;

FIG. 6 is a sectional view of joining means of the dental implant according to a second preferred embodiment of the present invention; and

FIG. 7 is an exploded perspective view of the joining means of FIG. 6.

### DETAILED DESCRIPTION OF THE PREFERRED EMBODIMENT

Reference will be now made in detail to the preferred embodiment of the present invention with reference to the attached drawings.

A dental implant 10 according to the present invention includes a fixture 20, an abutment 30, a screw 40, a crown 60, and joining means 100.

The fixture 20 is inserted and joined into a predetermined depth of an alveolar bone 1 through gums 2 to thereby form an artificial dental root.

The fixture 20 includes: a screw portion 21 formed on the outer periphery thereof and screw-coupled with the alveolar bone 1; and a screw coupler 22 formed on an inner portion of the top of the fixture 20 to thereby get screw-coupled with the screw 40.

In the meantime, the fixture 20 further includes a joining portion 23 protrudingly formed on the top of the fixture 20 in the form of a polygon, preferably, hexagon, to prevent rotation of the abutment 30 when the fixture 30 is joined with the abutment 30.

Moreover, the abutment 30 is adapted to connect and join the fixture 20 with the crown 60, and has an end portion inserted and joined into a joining recess 61 of the crown 60 and the other end portion joined with the fixture 20 through the screw 40.

In this instance, a portion of the outer periphery of the abutment 30 which is inserted into the joining recess 61 of the crown 60 is tapered, that is, an upper diameter of the abutment 30 is smaller than a lower diameter, so that the joining recess 61 of the crown 60 can be easily fit onto the abutment 30.

Furthermore, the abutment 30 has a concave portion 33 formed on the bottom surface of the abutment 30 to allow the polygonal joining portion 23 of the fixture 20 is inserted thereinto.

In this instance, the concave portion 33 has the same shape as the polygonal joining portion 23 of the fixture 20.

Meanwhile, the abutment 30 has an insertion hole 31 formed inside the abutment 30 to allow an insertion of the screw 40.

Additionally, the screw 40 serves to join the abutment 30 to the fixture 20, and includes: a head portion 41 inserted into the insertion hole 31 of the abutment 30; and a screw portion 42 that is formed at a lower end of the head portion 41, perforates the bottom of the abutment 30 and is screw-coupled with the screw coupler 22 of the fixture 20.

The insertion hole 31 of the abutment 30 has a stepped jaw 32 formed on a lower end thereof so that the head portion 41 of the screw 40 gets caught thereto.

In the meantime, the screw 40 has a sleeve groove 43 axially formed on the outer periphery of the head portion 41 to thereby easily rotate the screw 40 by a working tool, and in this instance, it is preferable that two sleeve grooves 43 are formed on the outer periphery of the head portion 41 at an angle of 180 degrees.

In addition, on the outer circumference of the abutment 30, the abutment 30 has a locking slit 34 formed at a location corresponding to the sleeve groove 43 of the screw 40 to prevent unscrewing of the screw 40.

In this instance, the sleeve groove 43 of the screw 40 and the locking slit 34 of the abutment 30 are communicated with each other.

In a state where the screw 40 and the abutment 30 are assembled with each other in such a way that the sleeve groove 43 of the screw 40 and the locking slit 34 of the abutment 30 coincide each other, a locking sleeve 50 is inserted into the sleeve groove 43 and the locking slit 34 or dental cement (not shown) is injected and filled into the sleeve groove 43 and the locking slit 34 to thereby prevent the unscrewing of the screw 40.

Moreover, the crown 60 forms the outward appearance of the crown and has the joining recess 61 that is formed therein and is opened toward the abutment 30.

The joining recess 61 has the same form as the tapered upper end portion of the abutment 30.

Furthermore, it is preferable that the crown 60 is made of zirconia, which has the highest intensity and aesthetic appreciation of ceramic materials.

The zirconia material is second only to metals in intensity after a heat treatment, but has difficulty in processing after the heat treatment. That is, zirconia is easy to process before the heat treatment, but is difficult to be produced as the dental crown 60 because it is difficult to carry out precision machining due to shrinkage of 20% to 30% during the heat treatment.

Therefore, the inventor of this invention has developed the joining means 100 to simply fasten and join the crown 60 made of zirconia to the abutment 30.

The joining means 100 includes: a first joining hole 101 formed at a side of the joining recess 61 of the crown 60; a second joining hole 102 formed on the outer periphery of the abutment 30 formed concentrically with the first joining hole 101; and a joining pin 110 inserted into the first joining hole 101 and the second joining hole 102 to connect and join the crown 60 and the abutment 30 with each other.

The first joining hole 101 formed in the crown 60 is formed on a side of the joining recess 61 of the crown 60 in a radial direction, namely, is formed at right angles to the axial direction of the screw 40.

In this instance, the first joining hole 101 completely penetrates from the inner periphery of the first joining hole 101 of the crown 60 to the outer face of the crown 60.

The second joining hole 102 formed in the abutment 30 completely penetrates from the inner periphery of the insertion hole 31 of the abutment 30 to the outer periphery of the abutment 30.

As described above, when the joining recess 61 of the crown 60 is fit and assembled onto the top of the abutment 30, the first joining hole 101 of the crown 60 and the second joining hole 102 of the abutment 30 are coincided with each other, and then, the joining pin 110 is inserted into the first joining hole 101 and the second joining hole 102, so that the crown 60 and the abutment 30 are coupled with each other.

Additionally, a housing 120 is joined to the first joining hole 101 of the crown 60 for supporting the outer periphery of the joining pin 110. In this instance, the housing 120 has a through hole 121 formed therein for allowing the joining pin 110 to penetrate therethrough.

As described above, because the crown 60 made of zirconia is difficult in precision machining, the precision-machined housing 120 is inserted and joined into the first joining hole 101 of the crown 60 to support the outer periphery of the joining pin 110, and then, there is no interval between the crown 60 and the joining pin 110, and it causes no interval between the crown 60 and the abutment 30, which are coupled with each other through the joining pin 110, whereby it improves durability of the implant 10.

Meanwhile, the housing 120 is permanently adhered on the first joining hole 101 of the crown 60 via dental cement.

Moreover, in order to prevent a separation of the joining pin 110, there are two embodiments as follows.

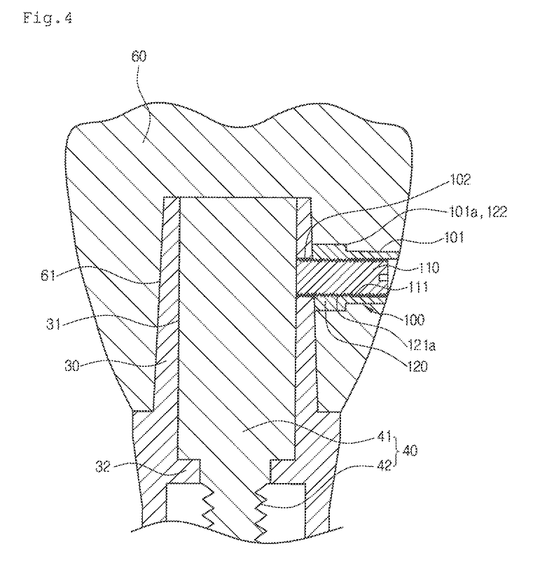

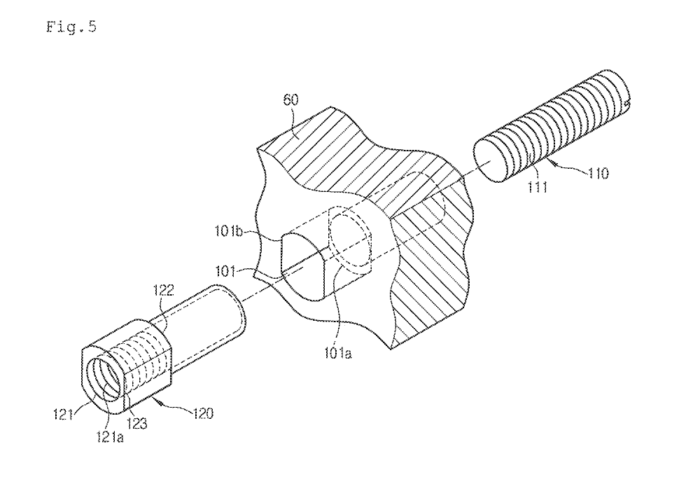

FIGS. 4 and 5 illustrate a first preferred embodiment to prevent the separation of the joining pin 110, wherein the joining pin 110 is screw-coupled to the inner periphery of the through hole 121 of the housing 120.

For this, the joining pin 110 has a screw portion 111 formed on the outer peripheral surface thereof and the through hole 121 of the housing 120 has a screw portion 121a formed on the inner peripheral surface thereof. In this instance, the screw portion 111 is formed on the entire outer peripheral surface of the joining pin 110, but the screw portion 121a is formed only a certain portion of the inner peripheral surface of the through hole 121 of the housing 120. Of course, the screw portion 121a may be formed on the entire inner peripheral surface of the through hole 121 of the housing 120.

In the meantime, because it is impossible to form a spiral line on the crown 60 made of zirconia, in order to screw couple the joining pin 110 with the crown 60, the housing 120 having the screw portion 121a must be inserted into the first joining hole 101 of the crown 60.

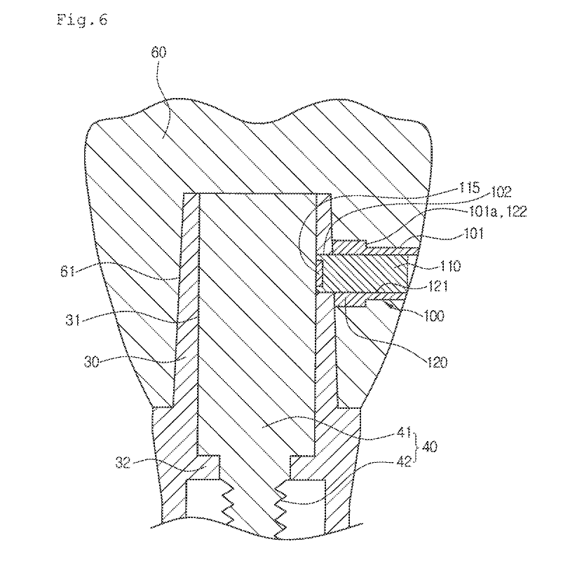

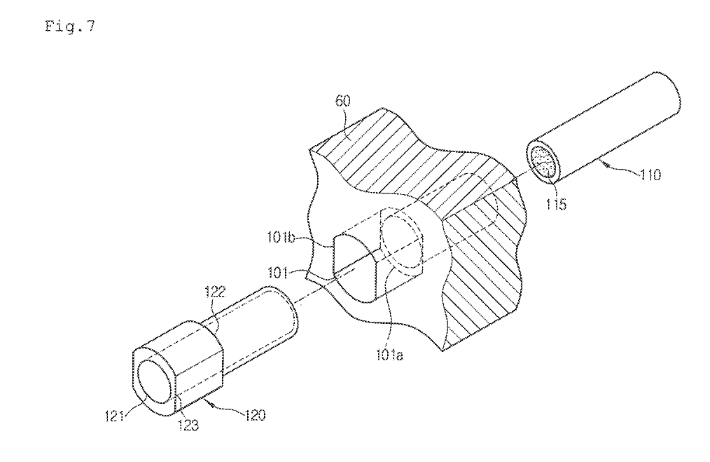

According to FIGS. 6 and 7 illustrating a second preferred embodiment, a magnet (115) is mounted at en end portion of the joining pin (110) to prevent a separation of the joining pin (110) via a magnetic force. At this moment, the magnet (115) mounted at an end portion of the joining pin (110) is fixed to the abutment 30 or the screw 40 inserted into the abutment 30 through a magnetic force.

In the case that the magnet 115 is mounted at the end portion of the joining pin 110, the screw portions are not formed on the outer peripheral surface of the joining pin 110 and on the inner peripheral surface of the housing 120.

Accordingly, when the joining pin 110 is slidably inserted into the housing 120 of the crown 60 and the second joining hole 102 of the abutment 30, the magnet 115 mounted at the end portion of the joining pin 110 is attached and fixed to the screw 40 located inside the abutment 30 via the magnetic force, and hence, the joining pin 110 is not separated.

Meanwhile, not shown in the drawings, but in order to fix the magnet 115 of the joining pin 110 to the abutment 30 via the magnetic force, the magnet 115 does not completely penetrate the second joining hole 102 of the abutment 30 but is formed to a predetermined depth.

Furthermore, also in the first preferred embodiment that the joining pin 110 is screw-coupled with the housing 120, the magnet 115 may be mounted at an end portion of the joining pin 110. That is, both of the screw-coupling and the magnet 115 can be applied in order to prevent the separation of the joining pin 110.

In this instance, the joining pin 110 is screw-coupled to the housing 120 and the magnet 115 mounted at the end portion of the joining pin 110 is fixed to the screw 40 located inside the abutment 30 via the magnetic force, whereby loosening of the joining pin 110 can be prevented.

Moreover, in order to prevent the housing 120 joined to the first joining hole 101 of the crown 60 from being separated to the outside of the crown 60, stepped portions 101a and 122 are respectively formed on joined faces of the first joining hole 101 and the housing 120.

In this instance, diameters of the first joining hole 101 and the housing 120, which are located inside the crown 60, are greater relative to the stepped portions 101a and 122.

Therefore, the housing 120 is inserted into the first joining hole 101 from the joining recess 61 of the crown 60, and after the insertion, is not separated to the outside of the crown 60.

Furthermore, in order to prevent a rotation of the housing 120 inside the first joining hole 101 of the crown 60, the first joining hole 101 and the housing 120 respectively have at least one flat portion 101b and 123 formed on the joined faces of the first joining hole 101 and the housing 120.

In the drawings, the housing 120 has two flat portions 123 formed on the outer peripheral surface thereof at an angle of 180 degrees, and the first joining hole 101 of the crown 60 also has two flat portions 101b formed on the inner peripheral surface thereof in correspondence with the flat portions 123 of the housing 120.

Meanwhile, because the crown 60 and the abutment 30 are connected and fixed to each other through the joining means 100, even though the dental cement is not applied between the crown 60 and the abutment 30, the crown 60 is not separated from the abutment 30.

However, in order to fix the crown 60 to the abutment 30, the dental cement and the joining means 100 can be all used at the same time. In this instance, even though the dental cement has weak adhesive force, the crown 60 is not separated from the abutment 30 due to the joining means 100. As described above, in the case that the dental cement and the joining means 100 are all used to fix the crown 60 to the abutment 30, even though the adhesive force of the dental cement gets weaker while patient uses the implant for a long term, the crown 60 is not separated due to the joining means 100.

In the meantime, because the present invention is characterized as the joining means 100, the structures of the fixture 20, the abutment 30 and the screw 40 can be varied, and the drawings just illustrate an example.

Hereinafter, an action of the dental implant 10 according to the present invention will be described. Because various methods of operating the implant 10 to the alveolar bone 1 have been previously disclosed and well-known, a detailed description of the method will be omitted, but now, a method of fixing the crown 60 to the abutment 30 using the joining means 100, which is the characteristic part of the present invention, will be described.

First, while the crown 60 made of zirconia is manufactured, the joining recess 61 and the first joining hole 101 are formed.

After that, the housing is temporarily assembled to the first joining hole 101 of the crown 60, and then, the abutment 30 is fixed to a reaming jig (not shown) in a state where the abutment 30 is inserted into the joining recess 61 of the crown 60.

After that, a position of a drill to form the second joining hole 102 on the outer periphery of the abutment 30 is determined, namely, the position of the drill is determined at a concentric position with the first joining hole 101 (housing 120) of the crown 60.

Continuously, when the drill position to form the second joining hole 102 is determined, the crown 60 is removed from the abutment 30, and then, the second joining hole 102 is formed in the abutment 30.

After the second joining hole 102 is formed in the abutment 30, the crown 60 is fit to the abutment 30 again, and then, a test joining pin is inserted into the housing 120 of the crown 60 and the second joining hole 102 of the abutment 30 to check whether or not the second joining hole 102 is formed in position.

After that, all of the abutment 30 and the crown 60 are removed from the reaming jig, and then, the housing 120 is permanently adhered on the first joining hole 101 of the crown 60 via the dental cement.

Then, the actual joining pin 110 is inserted into the housing 120 of the crown 60 and the second joining hole 102 of the abutment 30, and the length of the joining pin 110 is properly adjusted.

Through the above method, manufacturing of the joining means 100 for fixing the crown 60 to the abutment 30 is completely ended.

After that, the abutment 30 is joined to the fixture 20, which is previously planted in the alveolar hone 1 of the patient, through the screw 40, and then, the crown 60 is seated on the abutment 30.

Continuously, the joining pin 110 is inserted and fixed into the housing 120 of the crown 60 and the second joining hole 102 of the abutment 30, and in this instance, the joining pin 110 may be screw-coupled with the housing 120, and alternatively, the joining pin 110 having the magnet 115 is slidably inserted into the housing 120 and the second joining hole 102, so that the magnet 115 can be attached to the screw 40 via the magnetic force.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1-7. (canceled)

8. A dental implant, which includes a fixture inserted and joined into an alveolar bone to a predetermined depth to form an artificial dental root, a crown forming the outward appearance of the artificial root and having a joining recess that is formed therein and is opened at a side, an abutment having an end portion inserted and joined into the joining recess of the crown and the other end portion joined with the fixture, and joining means for joining the crown and the abutment with each other, wherein the joining means comprises:
a first joining hole penetrating a side of the joining recess of the crown;
a second joining hole formed on the outer periphery of the abutment, the second joining hole being formed concentrically with the first joining hole; and
a joining pin inserted into the first joining hole and the second joining hole to thereby couple and join the crown and the abutment with each other.

9. The dental implant according to claim 8, wherein a housing is joined to the first joining hole of the crown for supporting the outer periphery of the joining pin.

10. The dental implant according to claim 9, wherein the joining pin has a screw portion formed on the outer peripheral surface thereof and the housing has another screw portion formed on the inner peripheral surface thereof, so that the joining pin can be screw-coupled to the inner peripheral surface of the housing.

11. The dental implant according to claim 9, wherein stepped portions are respectively formed on joined faces of the first joining hole and the housing in order to prevent the housing joined to the first joining hole of the crown from being separated to the outside of the crown.

12. The dental implant according to claim 9, wherein the first joining hole and the housing respectively have at least one flat portion formed on the joined faces of the first joining hole and the housing in order to prevent the housing from being rotated inside the first joining hole of the crown.

13. The dental implant according to claim 8, where a magnet is mounted at an end portion of the joining pin to prevent a separation of the joining pin via a magnetic force.

14. The dental implant according to claim 9, where a magnet is mounted at an end portion of the joining pin to prevent a separation of the joining pin via a magnetic force.

15. The dental implant according to claim 10, wherein the crown is made of a zirconia material.

16. The dental implant according to claim 11, where a magnet is mounted at an end portion of the joining pin to prevent a separation of the joining pin via a magnetic force.

17. The dental implant according to claim 12, where a magnet is mounted at an end portion of the joining pin to prevent a separation of the joining pin via a magnetic force.

18. The dental implant according to claim 8, wherein the crown is made of a zironia material.

19. The dental implant according to claim 9, wherein the crown is made of a zironia material.

20. The dental implant according to claim 10, wherein the crown is made of a zironia material.

21. The dental implant according to claim 11, wherein the crown is made of a zironia material.

22. The dental implant according to claim 12, wherein the crown is made of a zironia material.
